(19) United States
(12) Patent Application Publication
(10) Pub. No.: US 2008/0252769 A1
(43) Pub. Date: Oct. 16, 2008

(54) Camera Arrangement, Mobile Phone Comprising a Camera Arrangement, Method of Manufacturing a Camera Arrangement

(75) Inventors: Emile Johannes Karel Verstegen, Eindhoven (NL); Arjen Gerben Van Der Sijde, Eindhoven (NL); Edwin Maria Wolterink, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,608

(22) PCT Filed: Jan. 24, 2005
(86) PCT No.: PCT/IB2005/050270

§ 371 Date: Aug. 1, 2006

(30) Foreign Application Priority Data
Feb. 6, 2004 (EP) 04100449.0

(51) Int. Cl. H04N 5/225

(52) U.S. Cl. 348/335; 348/E05.024

(57) ABSTRACT

The present invention relates to a camera arrangement as for instance used in a mobile phone that utilizes a liquid crystal based lens for providing an adjustable depth of focus. The camera arrangement comprises a photo sensor (201) array and at least two lenses (202, 203, 204) that are arranged in a fixed and unitary arrangement. At least one of the lenses (202) comprises a liquid crystal layer (101) that provides for adjustable focal length in that lens. The additional lens(-es) (203, 204) might have fixed or adjustable focal length depending on the application. According to one embodiment, the camera arrangement comprises at least one additional adjustable lens ant the lenses are arranged so as to provide for adjustable depth′ of focus as well as for an adjustable depth of field.

The market for camera arrangements as used in for instance mobile phones has increased tremendously in the last decade. The number of available features for mobile phones constantly increases with the growth of the market. Available features include full color displays, Internet connection, and message options. Mobile phones equipped with a built-in camera are one of the more recent contributions. Other application areas of such camera arrangements are for instance web-cams, security and surveillance equipment, and digital still and video cameras.

Current cameras, as for instance used in mobile phones, web-cams, or low-cost digital cameras usually have a single focal point. Such cameras are therefore designed with a reasonable focal depth making them relatively insensitive to differences in the focal distance for short-range objects. However, the fixed focal point results in relatively high sensitivity for differences in the focal distances for long-range objects. The resulting image is therefore often blurred, or has a blurred background.

Lenses with mechanical focus adjustments are often not an option due to space and cost limitations. One approach for solving this problem is to use a lens that has an auto focus functionality that enables sharp images at various distances. However, as of today there are no auto focus lenses available that meet the cost and space requirements put on mobile phone cameras. A crucial aspect for commercial success is ease of manufacturing.

US patent application 2002/0181126 discloses a lens that has a variable focal-length. According to one embodiment described therein, the lens comprises two transparent substrates that have concave surfaces provided with respective transparent electrode and orientation layers. The concave surfaces define a cell volume that is filled with liquid crystal molecules which have a negative anisotropy of index of refraction. The liquid crystal thus has an elliptic index of refraction that satisfies the following conditions:

nₑ<nₒₓ, nₑ<n_{oz} (1)

where nₑ is an index of refraction of an extraordinary, ray, nₒₓ is an index of refraction of an ordinary ray polarized in the X-direction, and n_{oz} is an index of refraction of an ordinary ray polarized in the Z-direction. For most liquid crystals, the index of refraction actually satisfies the following condition as well:

nₒₓ=nₒₓ=nₒ (2)

where nₒ is a polarization independent index of refraction of an ordinary ray.

The orientation films are arranged so that the liquid crystal molecules are oriented in parallel with the respective orientation film. However, when an AC or DC voltage is provided between the two electrodes, the orientation of liquid crystal molecules can be tilted 90° and an effective index of refraction n_{eff} relative to light impinging the lens is then lowered in accordance with the following equation:

n_{eff}=(nₑ+nₒ)/2 (3)

Due to this reduction of the index of refraction, the refracting power of the optical element diminishes and the lens thereby increases its focal length. Moreover, by controlling the voltage using a variable resistor, the focal length can be continuously varied. In effect, the lens exhibits a variable focal length.

US2002/0181126 does not describe the manufacturing of the device in any detail, but devices like this are commonly manufactured “piece-by-piece” and subsequently assembled into one unit. The concave “lens” surfaces of the device are particularly complicated to manufacture, since any surface defects or roughness will heavily impair the lens performance. Such surfaces are therefore typically made out of glass and are polished to their final shape. The electrodes necessary for the operation of the lenses are commonly applied on the inner side of the curved surfaces. The electrodes are typically applied by means of evaporation or sputtering. However, for steep or even stepped surfaces it is quite complicated to apply the electrodes using these methods. In addition, having the electrodes arranged on curved surfaces results in non-homogenous electric fields, affecting the accuracy of the lens.

Furthermore, as stated above, size is a critical factor in for instance mobile phone applications. Any attempt at using a lens as described in the above-mentioned patent application for a mobile phone application would therefore face serious problems in that the complete light path of the camera lens typically needs to accommodate not only the focus lens but also a primary lens, a collimator lens, and a photo sensor array.

Hence, there is a need for a lens that provides for a variable focus-length, compactness, and ease of manufacturing, and that thus is suitable for commercial application in a mobile phone. It is therefore an object of the present invention to provide a camera arrangement that is compact and facilitates ease of manufacturing.

The above object is met by the present invention as defined in the appended claims. Additional advantages will be apparent from the following description.

One aspect of the present invention thus provides a camera arrangement. The arrangement integrally comprises a photo sensor array and at least two lenses in a fixed configuration forming one unit. The photo sensor array comprises a large number of picture elements (i.e. pixels) that together form an image surface on which an object to be photographed is projected. At least a first one of the lenses has an adjustable focal length and comprises a liquid crystal cell that has a first alignment surface and a second alignment surface. At least one of the alignment surfaces is lens-shaped (e.g. convex or concave) and is defined by a polymer body. The liquid crystal cell further comprises liquid crystal molecules that have an anisotropic index of refraction and that are arranged between the alignment surfaces such that a predefined molecule orientation is induced. A pair of electrodes is furthermore provided on opposite sides of the liquid crystal molecules, and is thus operative to control an effective index of refraction in the layer of liquid crystal molecules by means of an electric field applied therein and reorienting the liquid crystal molecules.

The lenses are arranged in a fixed configuration such that the camera arrangement has an adjustable depth of focus. The adjustable focus depth can be exploited with e.g. an auto focus arrangement, controlled by an auto focus control unit, or with a manual focus arrangement, controlled by user input. The auto focus control unit typically comprises a range finder and a control unit. The control unit may include a lookup table that link different ranges with different lens settings. However, various auto focus control units are well known in the art and further description is therefore omitted.

The first lens thus operates based on the fact that the effective index of refraction in a layer of liquid crystal molecules depends on the liquid crystal molecule orientation in the layer, which in turn is controllable by an electrical field. However, the index of refraction is typically controllable only for light of a certain polarization that depends on the molecule orientation. For example, in case the alignment layers are parallel, the liquid crystal molecules are present in the nematic phase and are controllable between a parallel, uniaxial orientation and a tilted orientation. In the most tilted state, the molecules will typically have a homeotropic orientation, i.e. the molecules will be tilted 90°.

The change of index of refraction is then experienced only for light that is linearly polarized parallel with the molecule orientation. This circumstance can be handled in different ways. In case a polarization sensitive camera arrangement is acceptable, or even desired, a polarizer providing for the required polarization may be provided in the camera arrangement. Thus, according to one embodiment the first lens is operative for light of a predefined polarization that depends on the orientation of the liquid crystal molecules, and the camera arrangement further comprises a polarizer that is transparent for light of said predefined polarization only. This design is advantageous in that it provides for low cost, compact camera arrangements.

However, the polarizer will typically absorb at least 50% of impinging light (the portion not having the required polarization). This heavily reduces the amount of light that actually reaches the photo sensor array, resulting in lower brightness of the image.

Therefore, according to an alternative embodiment the first lens further comprises a second liquid crystal cell having a molecule orientation that is essentially perpendicular to the molecule orientation in the first liquid crystal cell. The two liquid crystal cells of the first lens are thus operative for light of opposite and complementary polarizations, whereby the first lens is operative for randomly polarized light. Provided that the focal point for the respective cells are accurately tuned, the two cells will act as a common, polarization independent lens.

According to one embodiment, the electrodes are arranged at essentially flat interfaces, e.g. on flat substrate surfaces. In such case, one of these flat surfaces might carry the lens-shaped polymer body, such that the electrodes are separated not only by the layer of liquid crystal molecules but also by the polymer body. Thereby the electrodes need not follow the concave or convex (lens-) shape of the liquid crystal/polymer interface but can instead be essentially flat and thus parallel with each other. This is advantageous since the resulting electric field is then more homogenous across the liquid crystal molecules. In effect, the electric field distribution will be very small as long as the dielectric constants of the polymer substrate and the ordinary and extraordinary dielectric constants of the liquid crystal molecules are of the same order. This thus results in a more uniform lens strength along the perimeter of the lens compared to electrodes arranged on a lens shaped surface. Furthermore, flat electrodes typically provide for easier manufacturing since sputtering or evaporation processes typically exploited are quite complicated to perform on bent surfaces. Still one advantage is that flat substrates might be formed out of glass or some other material having higher temperature resistance than the lens shaped polymer body. Applying the electrodes on a glass substrate instead of on a polymer surface can thus be performed at higher temperatures, providing for quicker and more accurate application processes.

However, the positions of the electrodes are not limited to this position. One or both electrodes might alternatively be provided in connection with the respective orientation layer and will then follow the shape of the respective liquid crystal interface.

Furthermore, segmented electrodes (e.g. electrodes that are divided into separately addressable sub-portions such as a center electrode portion and a circular electrode surrounding the center electrode) may be employed, whereby the lens can be even more accurately controlled. The electrode layers are contacted on the side portions. The electrode, or lead, is typically mounted with electrical conductive material, creating electrical contact between the lead and the conductive layer.

The camera arrangement thus facilitates an adjustable focus functionality that is based on a lens having adjustable focal length. However, more demanding camera applications might require not only an adjustable depth of focus but also an adjustable depth of field (e.g. a zoom functionality). Zoom functionality can be provided by a lens configuration comprising two lenses having separately adjustable focal lengths. Thus, according to one embodiment of the camera arrangement an additional, second lens has an adjustable focal length, and the first and second lenses are arranged such that the camera arrangement has an adjustable depth of field (i.e. the lenses are arranged in a telescope configuration). Preferably, but not necessarily, the second lens is designed in similar fashion as the first lens described above.

As is readily understood, the lenses in the camera arrangement can be arranged in many different ways. Furthermore, many lens configurations comprise a larger number of lenses with fixed and/or adjustable focal lengths. Obviously, any such lens configuration falls within the scope of the present invention. A characteristic feature of the camera arrangement according to the present invention is that is comprises lenses and a photo sensor array arranged at fixed distances from each other in an integral unit, and that at least one lens has an adjustable focal length that is controllable by reorienting liquid crystal molecules in a cell.

The camera arrangement according to the present invention is well suited for application directly on a circuit board, thereby allowing a very compact design. Another aspect of the present invention thus provides a circuit board carrying a camera arrangement as described above, together with additional electronic components.

Still one aspect of the present invention provides a mobile phone comprising a camera arrangement as described above.

The camera arrangement is particularly advantageous in that it facilitates a very rational manufacturing process. Thus, one aspect of the present invention provides a method of manufacturing a camera arrangement. The method includes the steps of:

forming a first lens that has an adjustable focal length and comprises liquid crystal molecules, said forming involving the steps of:

arranging a monomer between said first substrate and a mould, such that a lens-shaped body is formed on said first substrate;

polymerizing said monomer, thereby forming a lens-shaped polymer body on said first substrate;

removing said mould from said polymer body;

arranging an alignment layer on said polymer body;

providing a second substrate having an alignment layer;

sandwiching a layer of liquid crystal molecules between said polymer body and said second substrate, thereby forming a lens having an adjustable focal length.

The method further involves the steps of:

providing a second lens;

providing a photo sensor array; and

arranging said first lens, second lens, and photo sensor array in a fixed configuration forming one unit such that an adjustable depth of focus is provided for in the camera arrangement.

According to one embodiment, a sensor surface of said photo sensor array is exploited as first or second substrate. Thereby the camera arrangement can be simplified since the polymer body may be provided directly on the photo sensor array.

The step of polymerizing the monomer can be performed in many different ways. However, one particularly suitable approach is to use a photopolymerization process. Thus, according to one embodiment the step of polymerizing said monomer involves exposing said monomer to electromagnetic radiation. The electromagnetic radiation is preferably ultraviolet light, and the monomer may comprise a photo initiator that accelerates the photopolymerization process.

Alternatively, or in combination, the step of polymerizing involves heating the monomer to a temperature above 30° C. and preferably above 120° C. for post curing of the monomer. The particular temperature required depends largely on the type of monomer at hand as well as on the type of initiator used.

In case exposure to electromagnetic radiation is combined with heat treatment, exposing the monomer to electromagnetic radiation may have a primary function of setting the shape of the lens, enabling the lens to be released from its mould. However, polymerization of the monomer using electromagnetic radiation only is not likely to reach 100% since gelation and/or vitrification of the monomer will reduce the mobility of the reactive groups. A post-curing step at elevated temperatures in or above the indicated ranges is therefore preferably employed in order to temporarily increase the mobility and thus push the polymerization towards 100%.

However, the monomer may be heated already while exposed for the electromagnetic radiation. The simultaneous effect of radiation initiated polymerization and heat induced mobility during polymerization has a synergy effect on the rate of polymerization and thus push the polymerization closer to 100%.

The step of sandwiching a layer of liquid crystal molecules preferably exploits capillary forces that naturally occur in the cavity (i.e. the cell) between the polymer body and the second substrate. This is advantageous since it might otherwise be somewhat difficult to fill the cell completely.

In order to ensure a correct distance between, and alignment of, the first and second substrates, one embodiment utilizes spacer elements that are arranged between the two substrates. The spacer elements are then preferably glued to the respective substrate. However, according to one particular embodiment, the spacer elements are formed as an integral part of the polymer body during the polymerization step. This can be achieved, for example, by suitable configuration of the mould, whereby the spacer elements are defined at the same time as the lens-shaped body.

Alternatively the substrates may be fixed to each other solely by means of glue, for example an epoxy.

In order to control the orientation of the liquid crystal molecules, and thus the effective refractive index and the focal length of the lens, transparent electrodes are typically arranged on the respective substrate. The electrodes can be formed out of, for example, ITO (Indium Tim Oxide). On the second substrate, the electrode is typically arranged at the same side as the alignment layer, i.e. on the surface that faces the liquid crystal molecules. However, on the first substrate the electrode may be arranged on the substrate as such or it may be arranged on the polymer body. In case the electrode is arranged on the substrate as such, it is typically provided on the substrate before the polymer body is polymerized thereon. Provided that the first substrate as such is flat, application of an electrode is typically much easier than on a bent polymer surface. This is due both to the bent shape of the surface, complicating application processes such as evaporation and sputtering, and to the polymer, which typically is more heat sensitive than the substrate (that typically is formed out of glass).

The alignment layers on the respective substrates determine the liquid crystal molecule orientation that is induced in the cell. The alignment layers may for example be formed out of rubbed polyimide layers that each define an alignment direction (i.e. the so-called rubbing direction). The liquid crystal molecules are then oriented along the respective alignment direction.

A distinction can be made between polarization sensitive lenses and polarization insensitive lenses. A polarization sensitive lens is only controllable for light of a certain polarization. An example of such a lens is formed by a liquid crystal cell having parallel alignment layers, which induces a well-defined, uniaxial molecule orientation that is parallel with the direction of the respective alignment layers. The effective index of refraction n_{eff} of such a molecule configuration will be equal to nₑ for light that is linearly polarized parallel with the molecule orientation and no for light that is linearly polarized transversally to the molecule orientation. However, in case the molecules are tilted 90°, and thus have a homeotropic orientation, all light will experience an effective index of refraction that is equal to nₒ. In effect, the lens is uncontrollable for half of the light and is controllable between n, and nₑ for the other half of light. The switchable range for the index of refraction is thus limited by |nₒ−nₑ|.

Alternatively the liquid crystal molecules may be controllable between a homeotropic orientation and a “randomly” parallel orientation. The randomly parallel orientation is characterized in that the average molecule orientation is parallel with the plane of the substrate but that the molecules are randomly oriented in that plane. Such an orientation may be provided, for example, using alignment layers that induce a homeotropic orientation. The molecules are then homeotropically oriented when no electrical field is applied and are tilted to a randomly oriented planar state when a sufficient electrical field is applied. Since the alignment layer does not induce any directional orientation in the plane of the respective substrate, a random molecule orientation is ensured. Alternatively the same effect is feasible by using alignment layers that indeed induce a planar molecule orientation, but that do not induce a directional orientation in the respective plane. This is possible, for example, using layers of polyimide that are not rubbed. The effective index of refraction in such a layer will be nₒ for all light when the molecules are in the homeotropic orientation and will be (n₀+nₑ)/2 for all light when the molecules are randomly oriented in the plane of the respective substrate. Thus, this approach provides for polarization insensitive lenses having half the power of a polarization dependent counterpart described above. The switchable range for the index of refraction is thus limited by |(nₒ−nₑ₎/2|.

Yet another way to obtain a polarization insensitive lens is to use a helical arrangement of the liquid crystal molecules. In such case it is critical that the helical pitch within the liquid crystal mixture is smaller than the wavelength of visible light (<350 nm). Provided that this requirement is met, the effective refractive index of the liquid crystal mixture is essentially polarization insensitive for light above that wavelength. A comprehensive description of such lenses can be found in co-pending European patent application 03103936.5.

Hereinafter, embodiments of the camera arrangement according to the present invention will be described in further detail with reference to the accompanying, exemplifying drawings, on which:

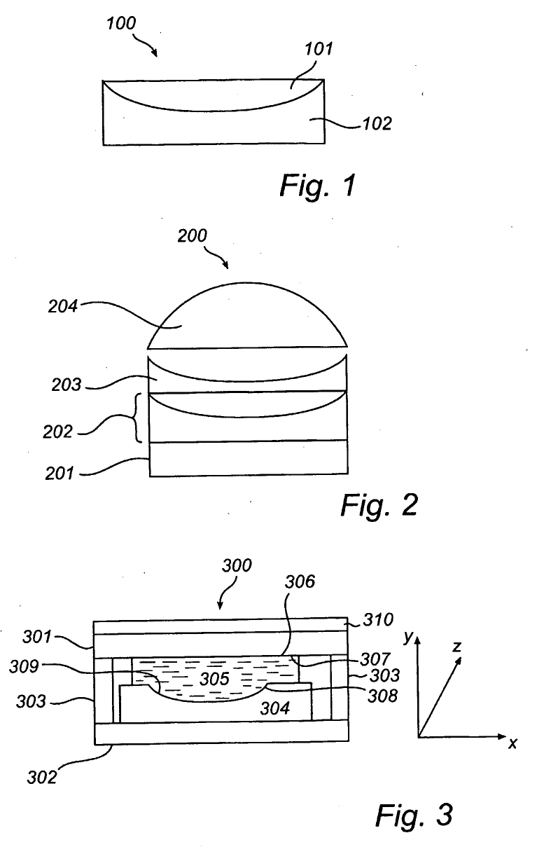

FIG. 1 shows a schematic representation of a liquid crystal lens.

FIG. 2 shows an example of an envisaged lens stack for a camera arrangement.

FIG. 3 shows a cross section of a liquid crystal switchable lens.

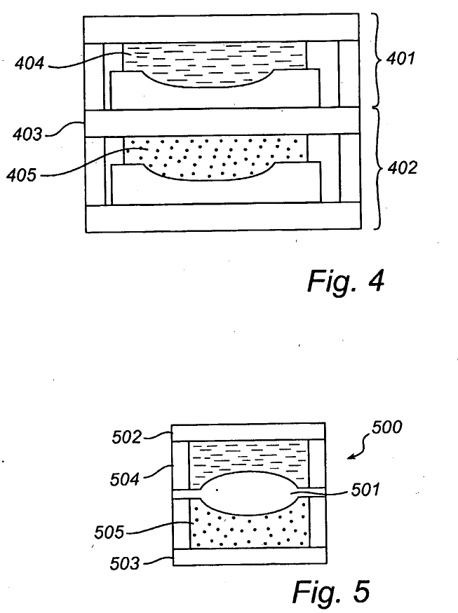

FIG. 4 shows a cross section of a liquid crystal switchable lens comprising two switchable liquid crystal layers.

FIG. 5 shows a cross section of a liquid crystal switchable lens comprising two switchable liquid crystal layers having one common polymer body.

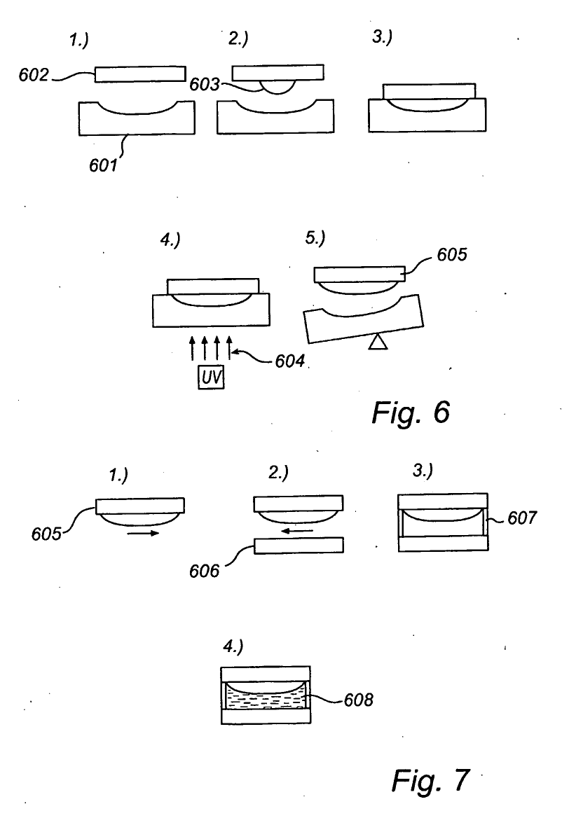

FIG. 6 illustrates a first step of an envisaged manufacturing process for a lens having adjustable focal length according to the present invention.

FIG. 7 illustrates a second step of an envisaged manufacturing process for a lens having an adjustable focal length according to the present invention.

FIG. 1 schematically illustrates a cross-section of an adjustable lens 100 that comprises a solid polymer body 102 and a switchable liquid crystal mixture 101. The solid polymer body 102 has a permanent index of refraction, whereas the liquid crystal mixture has a switchable index of refraction. To this end the liquid crystal molecules are switchable between two different extreme states, which determine the shortest and the longest focal lengths of the lens. Intermediate focal lengths can be provided for by exploiting intermediate molecule states. The configuration can also be arranged such that the concave shape is formed of a switchable liquid crystal and that the convex shape is formed out of a polymer body. Furthermore, some embodiments may have polymer bodies arranged on both substrates, such that an elliptic or biconcave liquid crystal body is formed. Such a liquid crystal body, having two optically active interfaces, will exhibit an increased focusing effect.

The variable focus lens is typically arranged next to the photo sensor array (e.g. a complementary metal oxide semiconductor (CMOS) imager). The entire lens stack comprises at least one more lens. FIG. 2 indicates schematically a possible setup for a lens stack 200 comprising a CMOS imager 201, a variable focus lens 202, a collimator lens 203, and a primary lens 204 stacked on each other in said order with the CMOS imager layer 201 being at the bottom. CMOS imagers are used here only as an example. A large number of alternative photo sensor arrays may be used instead, depending on the application at hand.

The total thickness of the liquid crystal lens stack lenses is mainly determined by the thickness of the substrates (that are typically formed out of glass), and is in the order of 0.5 to 5 mm depending on the configuration at hand and especially whether or not zoom lenses are incorporated (typically making the lens stack thicker). The total thickness of the entire lens stack may be in the order of 4 to 10 mm. The diameter may be about 8 mm including the casing.

One advantage of the present invention is that the polymer body might be formed using photoreplication, involving an in situ photopolymerization step, that allows for rapid prototyping and a wide variety of shapes that are relatively easily obtained as compared to e.g. glass polishing techniques. One particularly notable advantage is that waferscale processing is facilitated. The photopolymerization can, as stated above, be substituted or complemented by e.g. heat-induced polymerization.

The result of the polymerization process is a lens that can be integrated in a cell that is filled with liquid crystal molecules. Further cell processing is similar to the conventional steps presently used in standard liquid crystal display manufacturing.

Some embodiments comprise lenses having a fixed focal length. Such lenses are advantageously manufactured using similar polymerization steps as the polymer body intended for the liquid crystal lens.

An example of a switchable lens 300 according to the present invention is illustrated by the cross-sectional view of FIG. 3. This lens 300 comprises two substrates 301, 302 that together form a cell, which is sealed by spacer elements 303. The cell comprises a liquid crystal mixture 305 having positive anisotropy (nₑ>n₀), and a solid polymer body 304 having a concave surface interfacing the liquid crystal mixture 305. Transparent electrodes 306, 308 are provided on the respective substrates, and orientation layers 307, 309 are arranged at the respective liquid crystal interfaces. The orientation layers have parallel and, preferably, opposite rubbing directions, and thus induce a uniaxial orientation in the liquid crystal layer. To this end, the liquid crystal mixture is preferably chosen to be in the nematic phase. For explanatory reasons a 3D coordinate system is shown in FIG. 3. Referring to this coordinate system, the substrates extend in the XZ-plane, and the Y-direction defines the light path (i.e. the optical axis). The flat orientation layer 307 may thus be rubbed in the X-direction, and the concave orientation layer 309 may then be rubbed in the opposite X-direction. Electrode 308 may alternatively be arranged directly on the flat substrate 302.

Light traveling through the lens (in the Y-direction) and having a linear polarization along the rubbing direction (i.e. along the X-direction) will experience an effective index of refraction n_{eff} in the liquid crystal that is equal to the extraordinary index of refraction nₑ in the liquid crystal. However, in case the liquid crystal molecules are tilted out of the XZ-plane, the effective refractive index experienced by the linearly polarized light will change gradually towards the ordinary index of refraction n₀. In case the liquid crystal molecules are tilted 90°, and thus are parallel with the liquid crystal molecules, the effective refractive index will be equal to nₒ.

The effective index of refraction is a function of the tilt angle φ with respect to the XZ-plane as given by

$${n}_{eff} = \frac{{n}_{0} {n}_{e}}{\sqrt{{n}_{e}^{2} {sin}^{2} ϕ + {n}_{o}^{2} {cos}^{2} ϕ}}$$

The focal length of a liquid crystal lens that has a spherical interface with radius R between the lens-shaped polymer body and the layer of liquid crystal (i.e. a spherically shaped lens surface), where the liquid crystal has a convex shape and the solid has a concave shape, is given by:

$${f}_{LC} = \frac{R}{{n}_{eff} - {n}_{i}} .$$

where nᵢ is the (isotropic) index of refraction of the concave polymer body.

However, light that is not linearly polarized along the X-direction will not experience the shift of index of refraction. Such light will thus perceive the lens as being static, independent of any tilting of the liquid crystal molecule. In fact, such light will always experience an index of refraction equal to nₒ. In case the solid, concave body is formed out of a material having an isotropic index of refraction that is equal to nₒ such light will actually travel unaffected through the lens.

In order to provide for the required polarization, a linear polarizer 310 is typically provided on top of the lens structure 300. However, conventional polarizers are light absorbing, and thus polarize the light by absorbing any light rays having incorrect polarization. In effect, 50% of randomly polarized light is typically absorbed by the polarizer, resulting in a substantially decreased brightness.

Therefore, according to another embodiment, the lens is equipped with two superimposed liquid crystal cells—one for each polarization direction, as schematically illustrated by the cross-section of FIG. 4. To this end the lens may be provided with an additional liquid crystal cell 405 that differs from cell 404 only in the rubbing direction of the orientation layers. The lens thus comprises two lens portions 401, 402, which separately comprise all the elements of the lens illustrated in FIG. 3. However, the two portions may share one common substrate 403 and should preferably have their respective liquid crystals oriented perpendicular to each other (in the X- and Z-direction, respectively). In principle, each one of the substrate sides, that faces the liquid crystal either directly or indirectly via the polymer body, can have a separate electrode as to obtain 4 electrodes. The center electrodes can function as a shared common electrode by short wiring the respective electrodes. For certain suitable materials the two electrodes in the common substrate 403 can be exchanged for only one electrode on a single side. For one cell (404 or 405) the electrical field will then pass through the substrate. Having at least one electrode arranged at the common electrode 403 provides for individual switching of the cells and thus enables an accurate focusing effect for light of both polarizations.

Basically, two superimposed cells having perpendicular molecule orientations will result in a polarization independent lens since all light will be affected by one and only one of the two lenses. However, in order to provide sharp images the respective lens might have to be given a slightly different curvature and/or index of refraction difference in order to compensate for the slightly different focal lengths owing to the different position of the respective lens portion in the light path.

As stated above, the lens should preferably be as compact as possible. To this end the above polarization independent lens can be further simplified by removing the common substrate 403, instead using a design as illustrated in FIG. 5. According to this embodiment the lens 500 comprises two substrates 502, 503 and only one (common) solid lens body 501. The common lens body 501 shown has an ellipsoid shape that provides each liquid crystal layer 504, 505 with a convex interface. The lens need only two electrodes, one on each substrate 502, 503, which together provide for one common electric field across both liquid crystal layers. Of course, the ellipsoid shape can be interchanged for a biconcave shape in case concave interfaces are desired. In case an ellipsoid shape or a biconcave shape is employed, the liquid crystal mixtures in the two cells should preferably differ so that the effective index of refraction of one mixture is higher than the index of refraction of the polymer body and so that the effective index of refraction of the other liquid crystal mixture is equally lower than the index of refraction of the polymer body. Thereby the focusing effect of the two lens portions will have the same sign and magnitude (either positive or negative). An alternative solution is, of course, to use a polymer body having one concave surface and one convex surface. Thereby the same liquid crystal mixture can be employed for both lens portions while maintaining corresponding light focusing effects in the two lens portions (positive or negative).

In the embodiment illustrated in FIG. 5, only two electrodes are present. The respective cells can therefore not be tuned individually. Compared to individual addressing possibilities, accurate design and shape of the curved surfaces in the lens body 501 is more critical in order to ensure an overlapping focal point for the two cells.

The lens stack can have many different configurations, providing for e.g. adjustable depth of focus as well as for adjustable depth of field. In principle, any configuration that is operative for existing configurations (with moving lenses), can also be used with the liquid crystal lenses described herein. Two major advantages using liquid crystal lenses are that the building height can be reduced and that no moving parts are needed.

A zoom lens, providing for adjustable depth of field, requires at least two lenses, one lens having positive refracting power and one lens having negative refracting power and together forming a telescope setup.

The combination of a positive and a negative lens can increase or reduce the depth of field, and thus the zooming power, while maintaining an image parallel to the optical axis at all image locations.

Obviously, most lens stacks comprise not only one (or multiple) adjustable lens (-es) but also a number of lenses having fixed focal points. Such lenses may be formed similar to the lens shaped bodies in the adjustable liquid crystal lenses.

A variable focus lens as described above can be manufactured in two consecutive process steps. In a first process step, a solid body is manufactured by a photoreplication process as illustrated in FIG. 6 and involving the following steps:
1. A mould 601 is brought into place and treated such as to enable easy release of a photopolymerized product from the mould, and a transparent substrate 602 carrying a transparent conductor is prepared.
2. A small amount of monomer 603 is dispensed on the substrate 602 or in the mould 601. The monomer 603 is preferably degassed in order to avoid any gas bubbles inside the final product, and is furthermore mixed with a small amount of photo-initiator.
3. The mould 601 and the substrate 602 are brought together and any excess monomer is squeezed out from the thereby resulting cavity. In effect, the monomer is sandwiched between the mould and the substrate.
4. The monomer is subsequently exposed to ultraviolet light 604 and thereby polymerizes. The ultraviolet light 604 might enter the monomer 603 via the substrate 602, or via the mould 601 in case a transparent mould is employed. However, alternative polymerization processes are equally possible using for example heat. In such case the photo-initiator is typically omitted or exchanged for another suitable initiator.
5. Once polymerized, the solid body 605 can be released from the mould by slight bending of the mould or by a shock pulse.

In a second process step, the solid body that was prepared in the first process step is used for finalizing the component according to FIG. 7. The second process step involves the following steps:
1. An orientation layer is applied to the solid lens body 605. The orientation layer can be formed out of any available material suitable for such use, for example polyimide. In case polyimide is used a solution thereof might for example be spincoated and rubbed with a fabric after drying at an elevated temperature (e.g. 90°).
2. A second transparent substrate 606 carrying a second transparent electrode is provided with a second orientation layer. The same material and application technique can be used here as for the solid lens body 605. However, the substrates are typically formed out of glass and therefore withstand a substantially more intensive heat-treatment for curing the orientation layer. (e.g. 180°), thus enabling a more rapid curing process.
3. The solid lens body 605 and the second substrate 606 are subsequently joined together using glue and spacer elements 607 to ensure correct alignment. In case a parallel liquid crystal molecule orientation is desired, the elements are joined with their respective orientation layers in parallel. However, a twisted orientation is alternatively possible and might be provided by turning the orientation layers 90° in relation to each other. The spacer elements 607 may be separate elements or they may be integrated in either of the substrates or the polymer body.
4. The cell is finally filled with liquid crystal molecules 608 and sealed. The filling is typically quite easy due to naturally occurring capillary forces, and a droplet of glue can provide the sealing.

In case a polarization insensitive lens having two lens portions is desired, the steps may be repeated once again, typically using a substrate of the first portion as starting substrate for the second portion. In case separate electrodes are needed for each lens portion, that substrate of course needs to have one electrode layer on each side.

In case a lens as illustrated in FIG. 5 is desired, the monomer may be squeezed between two moulds. Both moulds have to be treated such as to enable easy release of the polymerized body. Both lens surfaces are thereafter arranged with alignment layers, for example polyimide that is rubbed in a perpendicular manner so as to provide for perpendicular orientations of the liquid crystal layers. Subsequently, the polymer body is arranged between two substrates, each equipped with an electrode and a rubbed alignment layer, using glue and spacer elements but leaving a small cavity for injecting the liquid crystal mixture. Thereafter, the two cells are filled with liquid crystal and finally a droplet of glue is used to close the cells.

In general, it is highly desirable to obtain cross-linked polymer chains in the polymer body making it more stable when exposed for chemical as well as thermal degradation. As stated above, the polymer body may be provided using a photo-initiator and UV-light. However, alternative ways of polymerizing the polymer body may be employed. To this end, two main polymerization mechanisms are identified; a first reaction is provided by a free radical initiated polymerization mechanism using a free radical photoinitiator, and a second reaction is provided by a cationic polymerization mechanism which typically is initiated by the use of Lewis acids. Non-limiting types of monomers that are suited for the free radical mechanism are comprised in the group consisting of (meth)acrylates and vinyl monomers. One example of such a monomer is 2,2-bis [4-(2-hydroxy-3-acryloylpropoxy)phenyl]propane (Bis-GAA). For the cationic reaction mechanism, epoxides, oxetanes and vinylether monomers can be used. One example of such a monomer is the diglycidyether of bisphenol-A.

The above mentioned monomers can all be thermally polymerized. Using suitable initiators, temperatures near room temperature will suffice.

As indicated above, the monomers may also contain a polymerization initiator. The initiator may be a free radical initiator, or an acid generator. Preferably a single initiator that can be activated both thermally and by electromagnetic radiation (e.g. UV radiation) is used. Azobisisobutyronitrile is one feasible example, although many azoesters may be used as well. Azoester-initiators have the advantage that they have, apart from their photochemical decomposition, a rather high decomposition rate at relatively low temperatures, making them usable also at low and only moderately high temperatures.

Examples of feasible photo-initiators which decompose only at higher temperatures are α-hydroxy-ketones, such as Irgacure 184 and Darocure 1173 (both trademarks of Ciba-Geigy AG); α-amino-ketones, such as Irgacure 907 and Irgacure 369 (both trademarks of Ciba-Geigy AG) and benzyldimethyl-ketal, such as Irgacure 651 (=DMPA: α,α-dimethoxy-α-phenyl-acetophenone) (trademark of Ciba-Geigy AG).

The above examples are all free radical initiators. There are two classes of acid generators suitable for cationic polymerization of certain monomers: diphenyliodonium salts (e.g. Diphenyliodonium hexafluoroarsenate) and triphenylsulfonium salts (Triphenylsulfonium hexafluoroantimonate). Both classes are so-called Lewis acids, and the variation lies mainly in the type of counterion. In the second class (triphenylsulfonium salts), the amount of phenyl rings varies as well, and each phenyl ring is connected by another one via a sulfur bond.

In addition to general photo-acid generators, various salts, or a mixture of salts, are feasible as well. Furthermore, an accelerator may be added in order to shift the absorbance spectrum or the efficiency of the initiators. Examples of feasible accelerators include anthracene or thioxanthone.

In essence, the present invention relates to a camera arrangement as for instance used in mobile phones that utilizes a liquid crystal based lens for providing an adjustable depth of focus. The camera arrangement thus comprises a photo sensor 201 array and at least two lenses 202, 203, 204 that are arranged in a fixed and unitary arrangement. At least one of the lenses 202 comprises a liquid crystal layer 101 that provides for adjustable focal length in that lens. The additional lens(-es) 203, 204 might have fixed or adjustable focal length depending on the application. According to one embodiment, the camera arrangement comprises at least one additional adjustable lens ant the lenses are arranged so as to provide for adjustable depth of focus as well as for an adjustable depth of field.

1. A camera arrangement (200), said arrangement integrally comprising at least two lenses (202, 203, 204) and a photo sensor array (201) in a fixed configuration forming one unit, wherein a first lens (202, 300) of said lenses has an adjustable focal length and comprises:
a first liquid crystal cell comprising a first alignment surface (307) and a second alignment surface (309), at least one of said alignment surfaces (307, 309) being a lens-shaped surface (309) defined by a polymer body (304), said liquid crystal cell further comprising a layer of liquid crystal molecules (305) that have an anisotropic index of refraction and that are arranged between said alignment surfaces (307, 309) such that a predefined molecule orientation is induced; and
a pair of electrodes (306, 308) provided on opposite sides of the layer of liquid crystal molecules (305) and operative to control an index of refraction in the layer of liquid crystal molecules (305) by means of an electric field applied therein;
wherein said lenses (202, 203, 2049 are arranged in said fixed configuration such that the camera arrangement has an adjustable depth of focus.

2. A camera arrangement (200) according to claim 1, wherein said first lens (202, 300) is operative for light of a predefined polarization that depends on the orientation of the liquid crystal molecules, and wherein said camera arrangement further comprises a polarizer (310) that is transparent for light of said predefined polarization only.

3. A camera arrangement (200) according to claim 1, wherein said first lens further comprises a second liquid crystal cell (402) having a molecule orientation that is essentially perpendicular to the molecule orientation in the first liquid crystal cell (402), such that the two liquid crystal cells (401, 402) are operative for light of opposite polarization, whereby the first lens is adjustable for randomly polarized light.

4. A camera arrangement (200) according to claim 1, wherein a second lens has an adjustable focal length and wherein said first and second lenses are arranged such that the camera arrangement has an adjustable depth of field.

5. A circuit board carrying a camera arrangement according to claim 1 together with additional electronic components.

6. A mobile phone comprising a camera arrangement according to claim 1.

7. A method of manufacturing a camera arrangement (200), said method including the steps of:
forming a first lens (202) that has an adjustable focal length and that comprises liquid crystal molecules, said forming involving the steps of:
arranging a monomer (603) between a first substrate (602) and a mould (601), such that a lens-shaped monomer body is formed on said first substrate;
polymerizing said monomer (604), thereby forming a lens-shaped polymer body on said first substrate;
removing said mould from said polymer body;
arranging an alignment layer on said polymer body;
providing a second substrate having an alignment layer;
arranging electrodes on said first and said second substrates;
sandwiching a layer of liquid crystal molecules (608) between said polymer body and said second substrate, thereby forming a lens having an adjustable focal length;
said method further involving the steps of:
providing a second lens (203, 204);
providing a photo sensor array (201); and
arranging said first lens (201), second lens (203, 204), and photo sensor array (201) in a fixed configuration forming one unit such that an adjustable depth of focus is provided for in the camera arrangement.

8. A method according to claim 7, wherein a sensor surface of said photo sensor array (201) is exploited as one of said first substrate and said second substrate.

9. A method according to claim 7, wherein the step of polymerizing involves exposing the monomer to electromagnetic radiation (604).

10. A method according to claim 9, wherein said electromagnetic radiation is ultraviolet light (604).

11. A method according to claim 7, wherein said step of polymerizing involves heating the monomer above 30° C. and preferably above 120° C.

12. A method according to claim 7, wherein capillary forces are exploited while sandwiching a layer of liquid crystal molecules.

13. A method according to claim 7, wherein spacer elements (607) are arranged between said first substrate and said second substrate.

14. A method according to claim 13, wherein said spacer elements (607) are formed out of a polymer, as an integral part of said polymer body.

15. A method according to claim 7, wherein transparent electrodes (306, 308) are provided directly on the respective substrates.

16. A method according to claim 7, wherein the alignment layers (307, 309) on said polymer body and said second substrate have essentially parallel but opposite alignment directions.

17. A method according to claim 7, wherein the electrode (308) that is arranged on said first substrate is arranged on said lens-shaped polymer body.
